(19) United States
(12) Patent Application Publication
(10) Pub. No.: US 2016/0224104 A1
(43) Pub. Date: Aug. 4, 2016

(54) ELECTRONIC SYSTEM WITH CAPTURE MECHANISM AND METHOD OF OPERATION THEREOF

(71) Applicant: Telenav, Inc., Sunnyvale, CA (US)

(72) Inventors: Aliasgar Mumtaz Husain, Milpitas, CA (US); Gregory Stewart Aist, San Mateo, CA (US); Stewart Chung-Tao Lin, San Mateo, CA (US); Eric Wood, Menlo Park, CA (US)

(21) Appl. No.: 15/013,326

(22) Filed: Feb. 2, 2016

Related U.S. Application Data
(60) Provisional application No. 62/111,041, filed on Feb. 2, 2015.

(51) Int. Cl. G06F 3/01; G10L 15/22; G06F 3/16

(52) U.S. Cl. CPC G06F 3/01; G06F 3/167; G10L 15/22; G10L 2015/223

(57) ABSTRACT

A method of operation of an electronic system includes: receiving a trigger for a capturable input including an activation phase, a pre-activation phase and a post-activation phase; generating an interpretation from the capturable input based on a portion of the capturable input including an activation phase with at least a portion from the pre-activation phase or the post-activation phase; and issuing an operation based on the interpretation.

### CROSS-REFERENCE TO RELATED APPLICATION(S)

This application claims the benefit of U.S. Provisional Patent Application Ser. No. 62/111,041 filed Feb. 2, 2015, and the subject matter thereof is incorporated herein by reference thereto.

### TECHNICAL FIELD

The present invention relates generally to an electronic system, and more particularly to a system with capture mechanism.

### BACKGROUND ART

Modern portable consumer and industrial electronics, especially client devices such as electronic systems, cellular phones, portable digital assistants, and combination devices, are providing increasing levels of functionality to support modern life including location-based information services. Research and development in the existing technologies can take a myriad of different directions.

As users become more empowered with the growth of mobile location based service devices, new and old paradigms begin to take advantage of this new device space. There are many technological solutions to take advantage of this new device location opportunity. Electronic systems and location based services enabled systems have been incorporated in automobiles, notebooks, handheld devices, and other portable products. However, an electronic system improving capture mechanism has become a paramount concern.

Thus, a need still remains for an electronic system with capture mechanism to improve entry capture and recognition In view of the increasing mobility of the workforce and social interaction, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems. Solutions to these problems have been long sought but prior developments have not taught or suggested any solutions and, thus, solutions to these problems have long eluded those skilled in the art.

### DISCLOSURE OF THE INVENTION

The present invention provides a method of operation of an electronic system including: receiving a trigger for a capturable input including an activation phase, a pre-activation phase and a post-activation phase; generating an interpretation from the capturable input based on a portion of the capturable input including an activation phase with at least a portion from the pre-activation phase or the post-activation phase; and issuing an operation based on the interpretation.

The present invention provides an electronic system, including a communication unit configured to receive a trigger for a capturable input including an activation phase, a pre-activation phase and a post-activation phase; a control unit, coupled to the communication unit, configured to generate an interpretation from the capturable input based on a portion of the capturable input including an activation phase with at least a portion from the pre-activation phase or the post-activation phase; and issue an operation based on the interpretation.

The present invention provides an electronic system having a non-transitory computer readable medium including: receiving a trigger for a capturable input including an activation phase, a pre-activation phase and a post-activation phase; generating an interpretation from the capturable input based on a portion of the capturable input including an activation phase with at least a portion from the pre-activation phase or the post-activation phase; and issuing an operation based on the interpretation.

Certain embodiments of the invention have other steps or elements in addition to or in place of those mentioned above. The steps or element will become apparent to those skilled in the art from a reading of the following detailed description when taken with reference to the accompanying drawings.

### BRIEF DESCRIPTION OF THE DRAWINGS

FIG. 1 is an example of an electronic system with capture mechanism in an embodiment.

FIG. 2 is an example of an application of the electronic system.

FIG. 3 is an example of phases of the capturable input.

FIG. 4 is an exemplary block diagram of the electronic system.

FIG. 5 is a control flow of the electronic system.

FIG. 6 is a flow chart of a method of operation of the electronic system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the electronic system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation.

The term “module” referred to herein can include software, hardware, or a combination thereof in the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof. Further, if a module is written in the apparatus claims section below, the modules are deemed to include hardware circuitry for the purposes and the scope of apparatus claims.

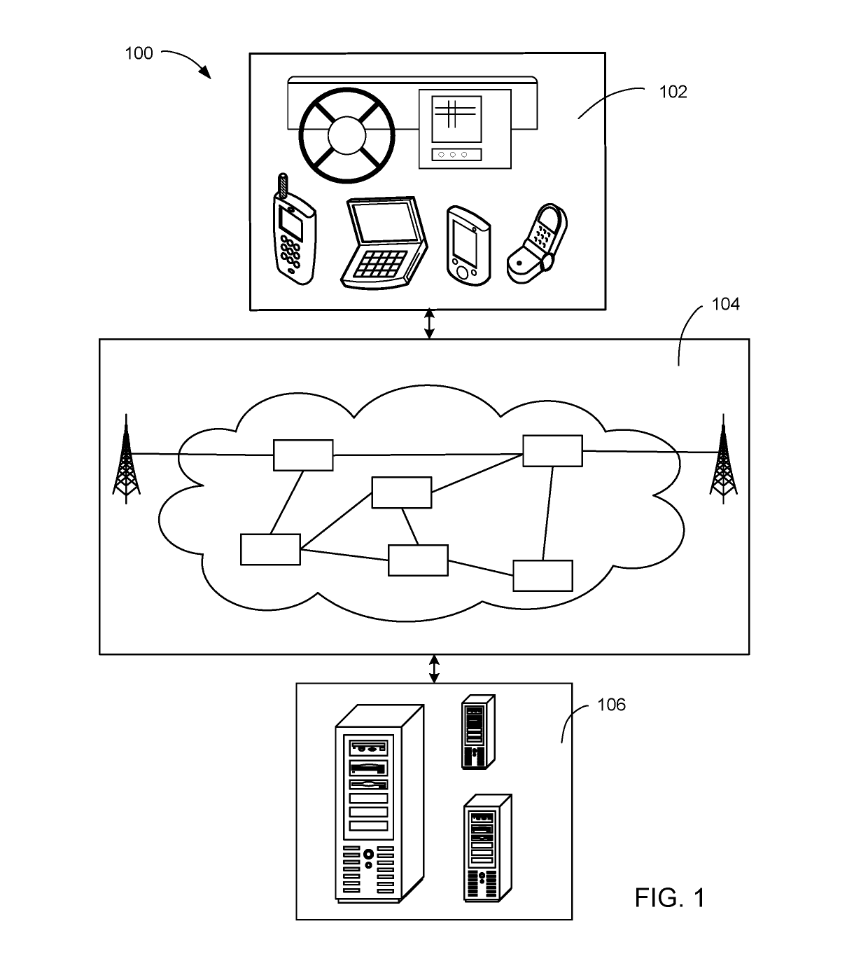

Referring now to FIG. 1, therein is shown an example of an electronic system 100 with capture mechanism in an embodiment. The electronic system 100 includes a first device 102, such as a client or a server, connected to a second device 106, such as a client or server, with a communication path 104, such as a wireless or wired network.

For example, the first device 102 can be of any of a variety of mobile devices, such as a cellular phone, personal digital assistant, a notebook computer, automotive telematic electronic system, or other multi-functional mobile communication or entertainment device. The first device 102 can be a standalone device, or can be incorporated with a vehicle, for example a car, truck, bus, or train. The first device 102 can couple to the communication path 104 to communicate with the second device 106.

For illustrative purposes, the electronic system 100 is described with the first device 102 as a mobile computing device, although it is understood that the first device 102 can be different types of computing devices. For example, the first device 102 can also be a non-mobile computing device, such as a server, a server farm, or a desktop computer. In another example, the first device 102 can be a particularized machine, such as a mainframe, a server, a cluster server, rack mounted server, or a blade server, or as more specific examples, an IBM System z10 (TM) Business Class mainframe or a HP ProLiant ML (TM) server.

The second device 106 can be any of a variety of centralized or decentralized computing devices. For example, the second device 106 can be a computer, grid computing resources, a virtualized computer resource, cloud computing resource, routers, switches, peer-to-peer distributed computing devices, or a combination thereof.

The second device 106 can be centralized in a single computer room, distributed across different rooms, distributed across different geographical locations, embedded within a telecommunications network. The second device 106 can have a means for coupling with the communication path 104 to communicate with the first device 102. The second device 106 can also be a client type device as described for the first device 102. Another example, the first device 102 or the second device 106 can be a particularized machine, such as a portable computing device, a thin client, a notebook, a netbook, a smartphone, a tablet, a personal digital assistant, or a cellular phone, and as specific examples, an Apple iPhone (TM), Android (TM) smartphone, or Windows (TM) platform smartphone.

For illustrative purposes, the electronic system 100 is described with the second device 106 as a non-mobile computing device, although it is understood that the second device 106 can be different types of computing devices. For example, the second device 106 can also be a mobile computing device, such as notebook computer, another client device, or a different type of client device. The second device 106 can be a standalone device, or can be incorporated with a vehicle, for example a car, truck, bus, or train.

Also for illustrative purposes, the electronic system 100 is shown with the second device 106 and the first device 102 as end points of the communication path 104, although it is understood that the electronic system 100 can have a different partition between the first device 102, the second device 106, and the communication path 104. For example, the first device 102, the second device 106, or a combination thereof can also function as part of the communication path 104.

The communication path 104 can be a variety of networks. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104.

Further, the communication path 104 can traverse a number of network topologies and distances. For example, the communication path 104 can include direct connection, personal area network (PAN), local area network (LAN), metropolitan area network (MAN), wide area network (WAN) or any combination thereof.

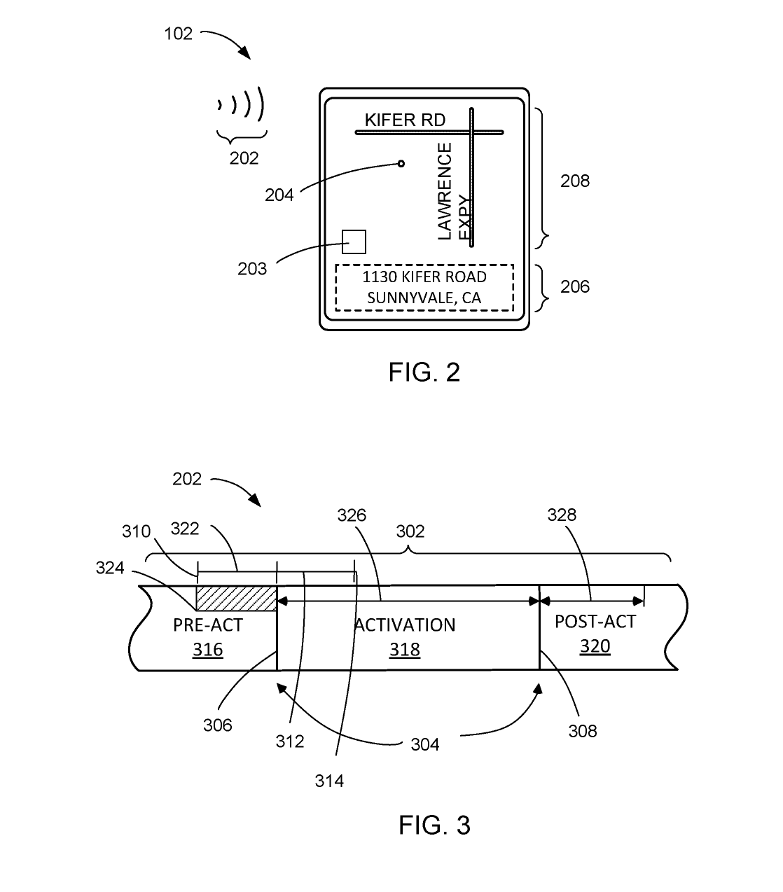

Referring now to FIG. 2, therein is shown a screen shot of an example of an application of an electronic system 100. The screen shot can represent the screen shot for the first device 102.

For illustrative purposes, the example shown in this figure is the first device 102 as a smartphone, although it is understood that the first device 102 can be other types of devices with this screen shot. For example, the screen shot shown in FIG. 2 can be part of a display have an automobile telematics system or in-dash system in an automobile. Also, this example shows the first device 102 operating as a navigation system for provide route guidance, point of interest information, location based services, or a combination thereof.

The screen shot depicts the electronic system 100 receiving a capturable input 202. The capturable input 202 is environmental information that can be captured or sensed by the electronic system 100. For example, the capturable input 202 can be audio, such as a user's utterance or voice command. As another example, the capturable input 202 can also be images, videos, air pressure, or a combination thereof.

A capture activation 203 can be utilized as a demarcation of intent to invoke receiving the capturable input 202. In this example, electronic system 100 can include portions of the capturable input 202 before the invocation of the capturable input 202.

The capture activation 203 can be implemented in a number of ways. The capture activation 203 can be an input mechanism to start receiving the capturable input 202. As examples, the capture activation 203 can be a button, a switch, a soft key on a screen, or a combination thereof. Also for example, the capture activation 203 can be part of a mobile device, or a car dash or steering wheel.

The capture activation 203 can also include sensors to detect a user's action before or to invoke the capture activation 203. For example, the capture activation 203 can be sensors to interpret user's action or gestures before the capture activation 203 is physically invoked or contacted. These sensors can include motion sensors, image sensors, air pressure sensors, light sensors, sound sensors, wireless signal sensors, or a combination thereof. The capture activation 203 can include sensors to detect specific gestures to invoke receiving the capturable input 202. Sensors can include proximity sensors with predefined motion patterns, such as waving twice in front of the sensor.

Continuing with the navigation example for the electronic system 100, the capturable input 202 can include an audio input for a user's desired location 204. In this example application, the capturable input 202 can be entered as “1130 Kifer Road Sunnyvale California”.

The electronic system 100 can process the capturable input 202 to determine a location identifier 206, which can include a designation of the user's desired location 204. The user's desired location 204 is a physical geographical location. The screen shot depicts the location identifier 206 as “1130 Kifer Road Sunnyvale California”. The screen shot also depicts the user's desired location 204 with a map 208.

For illustrative purposes, the electronic system 100 includes the location identifier 206 having a street address, a city name, and a state name, although it is understood that the electronic system 100 can have a different format for the location identifier 206. For example, the location identifier 206 can have different field depending on different country geographic designations, such as province or townships or unit number. The location identifier 206 can also refer to unique identification for rural areas of with different designation fields. The location identifier 206 can further represent a navigation identification with point of interest or an intersection.

Referring now to FIG. 3, there is shown an example of phases 302 of the capturable input 202. FIG. 3 depicts an example of how the capturable input 202 can be represented. Continuing with the example of the capturable input 202 as an audio input, the electronic system 100 of FIG. 1 can process the capturable input 202 by partitioning into the phases 302.

The phases 302 can represent different regions of based on triggers 304. The triggers 304 provide demarcation for processing the capturable input 202. As an example, the triggers 304 can be actions to the electronic system 100 to process the capturable input 202. As a further example, the triggers 304 can be actions sensed or detected by the electronic system 100 that be used to project an upcoming event for the electronic system 100 to process the capturable input 202. The triggers 304 can be invoked based on the capture activation 203 of FIG. 2.

The triggers 304 can include an activation trigger 306, a deactivation trigger 308, or a sensed trigger 310. The activation trigger 306 is an action to the electronic system 100 to invoke processing the capturable input 202. For example, the activation trigger 306 can be the capture activation 203, such as a button, being pressed to indicate capturing and processing an audio component from the capturable input 202.

The deactivation trigger 308 is an action to the electronic system 100 to stop processing the capturable input 202. The deactivation trigger 308 is optional. Continuing with the button example for the capture activation 203, the depression upon the button can be the activation trigger 306 and the release of the button or another depression of the button can serve as the deactivation trigger 308.

Also for example, the electronic system 100 can also terminate processing or stop detecting the capturable input 202 after a deactivation duration 312 from the activation trigger 306 or at a deactivation marker 314 within the capturable input 202. The deactivation duration 312 is an amount of time where the electronic system 100 stops processing the capturable input 202. The deactivation duration 312 can be measured from the activation trigger 306.

The deactivation marker 314 is a pattern in the capturable input 202 representing a potential termination or end in the capturable input 202 where the electronic system 100 can stop processing the capturable input 202. Continuing the audio example for the capturable input 202, the deactivation marker 314 can be an audio pause of a predetermined duration in the capturable input 202. The deactivation duration 312 can be used in conjunction with the deactivation marker 314 as the predetermined duration.

The sensed trigger 310 is an action detected by the electronic system 100 indicating a possible invocation of an upcoming event as the activation trigger 306. The sensed trigger 310 can be a pattern of movement of the hand or fingers on a steering wheel that the driver is about to push the button as the activation trigger 306. The sensed trigger 310 can also be a partial depression of the button, in this example. The partial depression can be an invocation by itself or as part of an action to fully depress the button.

Returning to the description of the phases 302 of the capturable input 202, the phases 302 can include a pre-activation phase 316, an activation phase 318, a post-activation phase 320, or a combination thereof. The activation phase 318 is a portion of the capturable input 202 after the activation trigger 306 has been invoked. In the example of the button, the activation trigger 306 is the button being pressed.

The pre-activation phase 316 is a portion of the capturable input 202 before the activation trigger 306 has been invoked. In the example of the button, this phase is before the activation trigger 306 or the button is pressed. A pre-activation length 322 for the pre-activation phase 316 can be based on different factors. The pre-activation length 322 is the amount before the activation trigger that can be considered a pre-activation phase 316 for that particular instance of the capturable input 202.

As an example, the pre-activation length 322 can be based on time and a predetermined amount of time before the activation trigger 306 can be considered time duration for the pre-activation length 322. As a further example, the pre-activation length 322 can be based on capture markers 324 found before the activation trigger 306.

The capture markers 324 are patterns in the capturable input 202 indicating possible discrete parts of the capturable input 202 for the electronic system 100 to demarcate what include or not for processing the capturable input 202. In the audio example for the capturable input 202, the capturable input 202 can be an audio pause of a predetermined duration. There may be more than one of the capture markers 324 in the pre-activation phase 316 where the electronic system 100 can process different portions from the pre-activation phase 316.

The activation phase 318 is the portion of the capturable input 202 where the electronic system 100 has been invoked with the activation trigger 306, such as the button being pressed, to process the capturable input 202. The activation phase 318 can also be a portion of the capturable input 202 where the electronic system 100 has sensed, with the sensed trigger 310, an upcoming invocation for the capturable input 202 to be processed.

The activation phase 318 can be for an activation length 326. The activation length 326 is the time duration where the electronic system 100 has been invoked to process the capturable input 202. The invocation can be based on the activation trigger 306, the sensed trigger 310, or a combination thereof. The end of the activation length 326 can be based on a number of factors.

For example, the activation length 326 can be based on a predetermined time from the activation trigger 306, the sensed trigger 310, or a combination thereof. Also for example, the activation length 326 can be based on the capture markers 324 that can be used by the electronic system 100 to determine discrete portions of the capturable input 202 for processing. As a further example, the activation length 326 can utilize both the predetermined time after one of the triggers 304 with the capture markers 324.

The post-activation phase 320 is the portion of the capturable input 202 where the electronic system 100 has determined as after the activation phase 318. The post-activation phase 320 can be the portion of the capturable input 202 beyond the activation length 326 for the activation phase 318.

The post-activation phase 320 can be for a post length 328 of the capturable input 202. The post length 328 is the time duration where the electronic system 100 can optionally process the capturable input 202 beyond the activation length 326. The post length 328 can also be determined by the capture markers 324 beyond the activation length 326.

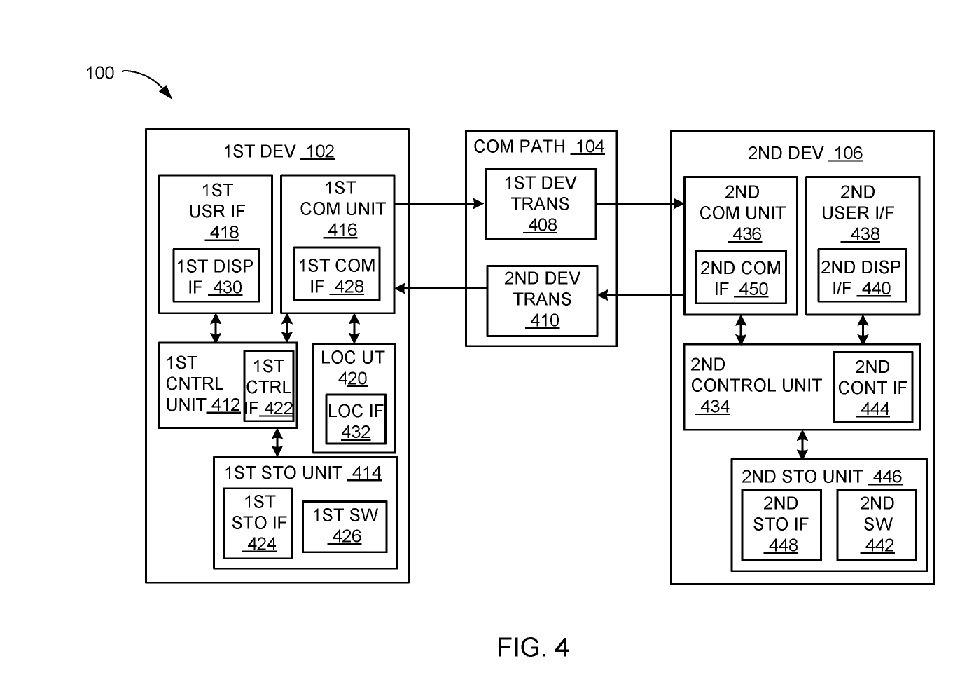

Referring now to FIG. 4, therein is shown an exemplary block diagram of the electronic system 100. The electronic system 100 can include the first device 102, the communication path 104, and the second device 106. The first device 102 can send information in a first device transmission 408 over the communication path 104 to the second device 106. The second device 106 can send information in a second device transmission 410 over the communication path 104 to the first device 102.

For illustrative purposes, the electronic system 100 is shown with the first device 102 as a client device, although it is understood that the electronic system 100 can have the first device 102 as a different type of device. For example, the first device 102 can be a server.

Also for illustrative purposes, the electronic system 100 is shown with the second device 106 as a server, although it is understood that the electronic system 100 can have the second device 106 as a different type of device. For example, the second device 106 can be a client device.

For brevity of description in this embodiment of the present invention, the first device 102 will be described as a client device and the second device 106 will be described as a server device. The present invention is not limited to this selection for the type of devices. The selection is an example of the present invention.

The first device 102 can include a first control unit 412, a first storage unit 414, a first communication unit 416, a first user interface 418, and a location unit 420. The first control unit 412 can include a first control interface 422. The first control unit 412 can execute a first software 426 to provide the intelligence of the electronic system 100. The first control unit 412 can be implemented in a number of different manners. For example, the first control unit 412 can be a processor, an embedded processor, a microprocessor, a hardware control logic, a hardware finite state machine (FSM), a digital signal processor (DSP), or a combination thereof. The first control interface 422 can be used for communication between the first control unit 412 and other functional units in the first device 102. The first control interface 422 can also be used for communication that is external to the first device 102.

The first control interface 422 can receive information from the other functional units or from external sources, or can transmit information to the other functional units or to external destinations. The external sources and the external destinations refer to sources and destinations physically separate from the first device 102.

The first control interface 422 can be implemented in different ways and can include different implementations depending on which functional units or external units are being interfaced with the first control interface 422. For example, the first control interface 422 can be implemented with a pressure sensor, an inertial sensor, a microelectromechanical system (MEMS), optical circuitry, waveguides, wireless circuitry, wireline circuitry, or a combination thereof.

The location unit 420 can generate location information, current heading, and current speed of the first device 102, as examples. The location unit 420 can be implemented in many ways. For example, the location unit 420 can function as at least a part of a global positioning system (GPS), an inertial electronic system, a cellular-tower location system, a pressure location system, or any combination thereof.

The location unit 420 can include a location interface 432. The location interface 432 can be used for communication between the location unit 420 and other functional units in the first device 102. The location interface 432 can also be used for communication that is external to the first device 102.

The location interface 432 can receive information from the other functional units or from external sources, or can transmit information to the other functional units or to external destinations. The external sources and the external destinations refer to sources and destinations physically separate from the first device 102.

The location interface 432 can include different implementations depending on which functional units or external units are being interfaced with the location unit 420. The location interface 432 can be implemented with technologies and techniques similar to the implementation of the first control interface 422.

The first storage unit 414 can store the first software 426. The first storage unit 414 can also store the relevant information, such as advertisements, points of interest (POI), navigation routing entries, or any combination thereof.

The first storage unit 414 can be a volatile memory, a nonvolatile memory, an internal memory, an external memory, or a combination thereof. For example, the first storage unit 414 can be a nonvolatile storage such as non-volatile random access memory (NVRAM), Flash memory, disk storage, or a volatile storage such as static random access memory (SRAM).

The first storage unit 414 can include a first storage interface 424. The first storage interface 424 can be used for communication between the location unit 420 and other functional units in the first device 102. The first storage interface 424 can also be used for communication that is external to the first device 102.

The first storage interface 424 can receive information from the other functional units or from external sources, or can transmit information to the other functional units or to external destinations. The external sources and the external destinations refer to sources and destinations physically separate from the first device 102.

The first storage interface 424 can include different implementations depending on which functional units or external units are being interfaced with the first storage unit 414. The first storage interface 424 can be implemented with technologies and techniques similar to the implementation of the first control interface 422.

The first communication unit 416 can enable external communication to and from the first device 102. For example, the first communication unit 416 can permit the first device 102 to communicate with the second device 106, an attachment, such as a peripheral device or a computer desktop, and the communication path 104.

The first communication unit 416 can also function as a communication hub allowing the first device 102 to function as part of the communication path 104 and not limited to be an end point or terminal unit to the communication path 104. The first communication unit 416 can include active and passive components, such as microelectronics or an antenna, for interaction with the communication path 104.

The first communication unit 416 can include a first communication interface 428. The first communication interface 428 can be used for communication between the first communication unit 416 and other functional units in the first device 102. The first communication interface 428 can receive information from the other functional units or can transmit information to the other functional units.

The first communication interface 428 can include different implementations depending on which functional units are being interfaced with the first communication unit 416. The first communication interface 428 can be implemented with technologies and techniques similar to the implementation of the first control interface 422.

The first user interface 418 allows a user (not shown) to interface and interact with the first device 102. The first user interface 418 can include an input device and an output device. Examples of the input device of the first user interface 418 can include a keypad, a touchpad, soft-keys, a keyboard, a microphone, a camera, or any combination thereof to provide data and communication inputs.

The first user interface 418 can include a first display interface 430. The first display interface 430 can include a display, a projector, a video screen, a speaker, a headset, or any combination thereof.

The first user interface 418 can also include sensors for detection actions or the environment surrounding or involving the first device 102. In the example where the first device 102 is an automobile, these sensors of the first user interface 418 can detect position, movement, patterns of movements, or a combination thereof along a steering wheel. These sensors can detect patterns of positions or movements or pressures indicated that an upcoming and imminent invocation for the activation trigger 306 of FIG. 3.

The first control unit 412 can operate the first user interface 418 to display information generated by the electronic system 100. The first control unit 412 can also execute the first software 426 for the other functions of the electronic system 100, including receiving location information from the location unit 420. The first control unit 412 can further execute the first software 426 for interaction with the communication path 104 via the first communication unit 416.

The second device 106 can be optimized for implementing the present invention in a multiple device embodiment with the first device 102. The second device 106 can provide the additional or higher performance processing power compared to the first device 102. The second device 106 can include a second control unit 434, a second communication unit 436, and a second user interface 438.

The second user interface 438 allows a user (not shown) to interface and interact with the second device 106. The second user interface 438 can include an input device and an output device. Examples of the input device of the second user interface 438 can include a keypad, a touchpad, soft-keys, a keyboard, a microphone, a camera, or any combination thereof to provide data and communication inputs. Examples of the output device of the second user interface 438 can include a second display interface 440. The second display interface 440 can include a display, a projector, a video screen, a speaker, a headset, or any combination thereof

The second control unit 434 can execute a second software 442 to provide the intelligence of the second device 106 of the electronic system 100. The second software 442 can operate in conjunction with the first software 426. The second control unit 434 can provide additional performance compared to the first control unit 412.

The second control unit 434 can operate the second user interface 438 to display information. The second control unit 434 can also execute the second software 442 for the other functions of the electronic system 100, including operating the second communication unit 436 to communicate with the first device 102 over the communication path 104.

The second control unit 434 can be implemented in a number of different manners. For example, the second control unit 434 can be a processor, an embedded processor, a microprocessor, a hardware control logic, a hardware finite state machine (FSM), a digital signal processor (DSP), or a combination thereof.

The second control unit 434 can include a second control interface 444. The second control interface 444 can be used for communication between the second control unit 434 and other functional units in the second device 106. The second control interface 444 can also be used for communication that is external to the second device 106.

The second control interface 444 can receive information from the other functional units or from external sources, or can transmit information to the other functional units or to external destinations. The external sources and the external destinations refer to sources and destinations physically separate from the second device 106.

The second control interface 444 can be implemented in different ways and can include different implementations depending on which functional units or external units are being interfaced with the second control interface 444. For example, the second control interface 444 can be implemented with a pressure sensor, an inertial sensor, a microelectromechanical system (MEMS), optical circuitry, waveguides, wireless circuitry, wireline circuitry, or a combination thereof.

A second storage unit 446 can store the second software 442. The second storage unit 446 can also store the relevant information, such as advertisements, points of interest (POI), navigation routing entries, or any combination thereof. The second storage unit 446 can be sized to provide the additional storage capacity to supplement the first storage unit 414.

For illustrative purposes, the second storage unit 446 is shown as a single element, although it is understood that the second storage unit 446 can be a distribution of storage elements. Also for illustrative purposes, the electronic system 100 is shown with the second storage unit 446 as a single hierarchy storage system, although it is understood that the electronic system 100 can have the second storage unit 446 in a different configuration. For example, the second storage unit 446 can be formed with different storage technologies forming a memory hierarchal system including different levels of caching, main memory, rotating media, or off-line storage.

The second storage unit 446 can be a volatile memory, a nonvolatile memory, an internal memory, an external memory, or a combination thereof. For example, the second storage unit 446 can be a nonvolatile storage such as non-volatile random access memory (NVRAM), Flash memory, disk storage, or a volatile storage such as static random access memory (SRAM).

The second storage unit 446 can include a second storage interface 448. The second storage interface 448 can be used for communication between the location unit 420 and other functional units in the second device 106. The second storage interface 448 can also be used for communication that is external to the second device 106.

The second storage interface 448 can receive information from the other functional units or from external sources, or can transmit information to the other functional units or to external destinations. The external sources and the external destinations refer to sources and destinations physically separate from the second device 106.

The second storage interface 448 can include different implementations depending on which functional units or external units are being interfaced with the second storage unit 446. The second storage interface 448 can be implemented with technologies and techniques similar to the implementation of the second control interface 444.

The second communication unit 436 can enable external communication to and from the second device 106. For example, the second communication unit 436 can permit the second device 106 to communicate with the first device 102 over the communication path 104.

The second communication unit 436 can also function as a communication hub allowing the second device 106 to function as part of the communication path 104 and not limited to be an end point or terminal unit to the communication path 104. The second communication unit 436 can include active and passive components, such as microelectronics or an antenna, for interaction with the communication path 104.

The second communication unit 436 can include a second communication interface 450. The second communication interface 450 can be used for communication between the second communication unit 436 and other functional units in the second device 106. The second communication interface 450 can receive information from the other functional units or can transmit information to the other functional units.

The second communication interface 450 can include different implementations depending on which functional units are being interfaced with the second communication unit 436. The second communication interface 450 can be implemented with technologies and techniques similar to the implementation of the second control interface 444.

The first communication unit 416 can couple with the communication path 104 to send information to the second device 106 in the first device transmission 408. The second device 106 can receive information in the second communication unit 436 from the first device transmission 408 of the communication path 104.

The second communication unit 436 can couple with the communication path 104 to send information to the first device 102 in the second device transmission 410. The first device 102 can receive information in the first communication unit 416 from the second device transmission 410 of the communication path 104. The electronic system 100 can be executed by the first control unit 412, the second control unit 434, or a combination thereof.

For illustrative purposes, the second device 106 is shown with the partition having the second user interface 438, the second storage unit 446, the second control unit 434, and the second communication unit 436, although it is understood that the second device 106 can have a different partition. For example, the second software 442 can be partitioned differently such that some or all of its function can be in the second control unit 434 and the second communication unit 436. Also, the second device 106 can include other functional units not shown in FIG. 4 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the electronic system 100 is described by operation of the first device 102 and the second device 106. It is understood that the first device 102 and the second device 106 can operate any of the modules and functions of the electronic system 100. For example, the first device 102 is described to operate the location unit 420, although it is understood that the second device 106 can also operate the location unit 420.

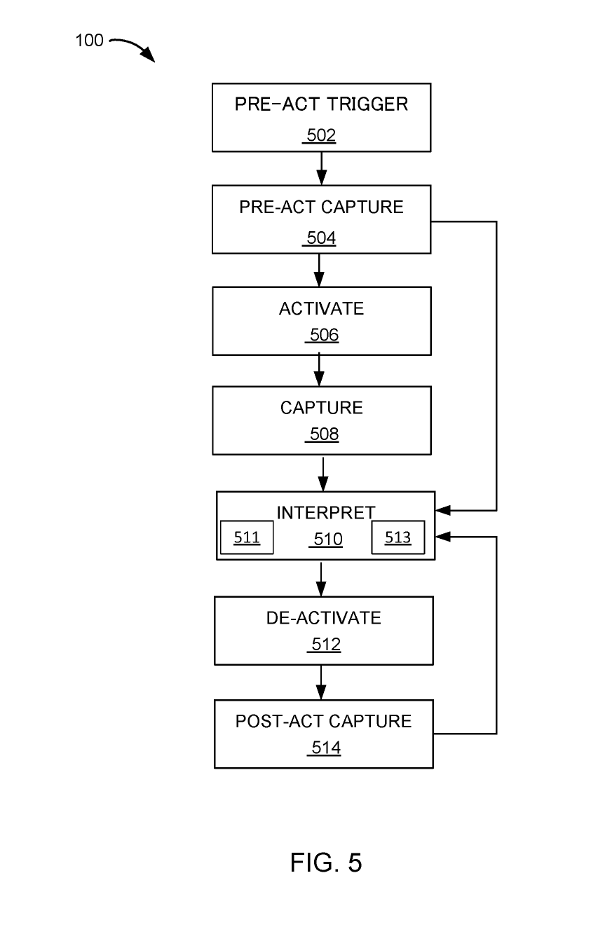

Referring now to FIG. 5, therein is shown a control flow of the electronic system 100. The electronic system 100 can include a pre-activation trigger module 502, a pre-activation capture module 504, an activate module 506, a capture module 508, an interpret module 510, a de-activate module 512, a post-activation capture module 514, or a combination thereof.

FIG. 5 depicts as an example modules, the order of the modules, and the flow progression. Various embodiments can differ from what is depicted in FIG. 5. For example, the pre- activation trigger module 502, the de-activate module 512, the post-activation capture module 514, or a combination thereof can be optional. The flow can progress as if though those modules did not exist or operationally, those modules can be treated as mere pass-through.

The pre-activation trigger module 502 detects or receives a trigger for processing a portion of the capturable input 202 of FIG. 2. The pre-activation trigger module 502 can detect the sensed trigger 310 of FIG. 3 to commence processing the capturable input 202 as the pre-activation phase 316 of FIG. 3.

The pre-activation trigger module 502 can also function in a pass through mode or an option where no specific trigger is required to start the pre-activation phase 316 for the capturable input 202. In this example, the pre-activation trigger module 502 can function as being triggered. The flow can progress to the pre-activation capture module 504.

The pre-activation capture module 504 captures the capturable input 202. As an example, the pre-activation capture module 504 can operate without the detection of the activation trigger 306, the sensed trigger 310, or a combination thereof.

The pre-activation capture module 504 can be continuously operate and capture the capturable input 202 continuously. The pre-activation capture module 504 can limit how much can be captured. The pre-activation capture module 504 can capture with a limit of the pre-activation length 322, a predetermined number of the capture markers 324 of FIG. 3, or a combination thereof. The pre-activation capture module 504 can capture the pre-activation phase 316 of FIG. 3 and this portion can be determined when the electronic system 100 is invoked to process the capturable input 202. The flow can progress to the activate module 506.

The activate module 506 detects the invocation of the electronic system 100 to process the capturable input 202. For example, the electronic system 100 can be invoked by the detection of the activation trigger 306, the sensed trigger 310, or a combination thereof. The detection of one of these triggers can indicate the start of the activation phase 318 of FIG. 3 of the capturable input 202. This detection can also mark how much before the activation trigger 306 or the sensed trigger 310 the capturable input 202 can be considered the pre-activation phase 316. The flow can progress to the capture module 508.

The capture module 508 receives the capturable input 202. The capture module 508 can operate on the activation phase 318 of the capturable input 202. The capture module 508 can operate for the activation length 326 of FIG. 3. The flow can progress to the interpret module 510.

The interpret module 510 performs recognition from the capturable input 202. The interpret module 510 can generate an interpretation 511 of the capturable input 202. The interpretation 511 represent recognizable commands or words or objects that can be utilized by other parts of the electronic system 100 or external to the electronic system 100. The interpretation 511 can be utilized to issue an operation 513. The operation 513 can be used to control or affect parts of the electronic system 100 or external to the electronic system 100. As examples, the operation 513 can be to control the functionality of the electronic system 100, provide a response from the electronic system 100, or a combination thereof.

As an example, the interpret module 510 can interpret the activation phase 318 of the capturable input 202. However, the activation phase 318 may not necessarily include enough of the capturable input 202 to interpret the capturable input 202.

In the examples of navigation instructions, the activation phase 318 represents when car-microphone begins listening after the press and release of listening activation button. It is only natural for people to start talking before their thumb presses the button, and hence part of the utterance as the capturable input 202 is lost. This loss of a portion of the capturable input 202 can result in misrecognition or losing out on the initial part of the utterance, which can be a command.

Continuing with the example, the interpret module 510 can use the pre-activation phase 316. The pre-activation phase 316 can be from the pre-activation capture module 504. The interpret module 510 can use the activation phase 318 and a portion of the pre-activation phase 316 to interpret and process the capturable input 202.

The interpret module 510 can utilize the pre-activation phase 316 in a number for ways. For example, the interpret module 510 can process a portion of the pre-activation phase 316 demarcated by the nearest instance of the capture markers 324 of FIG. 3 to the beginning of the activation phase 318. This combination can be used to interpret the capturable input 202.

If the interpretation is not found or the interpretation is not reliable or has a low confidence level, the interpret module 510 can process more of the pre-activation phase 316 with the activation phase 318. The interpret module 510 can determine if there is another instance of the capture markers 324 in the pre-activation phase 316 further away from the activation phase 318. If there is, that portion can be combined with the activation phase 318 to interpret the capturable input 202.

This process can continue through the pre-activation length 322 until the interpretation is successful or has a confidence level high enough to be deemed an accurate interpretation or to present a select number of possible interpretation options. Also, the interpret module 510 can also start with the pre-activation phase 316 for the entire length provided by the pre-activation length 322.

As a specific example, the capturable input 202 as a speaker's utterance can be buffered to a temporary register all the time. This buffering can be done by the pre-activation capture module 504. The pre-activation length 322 can represent a total time of recording, which can be configurable and short. For example, pre-activation length 322 5 seconds. This is cached and can be continuously overwritten, so at no point the buffered/cached utterance is more than 5 seconds. This is not uploaded to cloud or sent to the (cloud or embedded) recognizer, until the listening-activation button is pressed. The cloud or the recognizer can be the second device 106 of FIG. 1.

Continuing the audio example for the capturable input 202, there is a limited-size buffer, that caches the audio stream at all times to the extent of the size of the buffer and recycles the buffer to that extent.

As the listening activation button is pressed, this can serve as the activation trigger 306. At this time, this acts as a time marker (t₀) and sends the preceding audio(t₋ₙ) and opens the microphone for the rest of the utterance until end-point is reached (tₘ) or listening activation button is pressed again (signaling the end). The end-point can be based on the factors for the activation length 326.

As a specific example, after the whole utterance is completed, either the whole utterance is sent to the second device 106 functioning as the recognizer after the utterance is completed in a buffer-and-upload or sent as the utterance is going on, in streaming mode.

Once the second device 106, functioning as a recognizer, receives the whole utterance from t₋ₙ->t₀->tₘ, recognizer tries to check start point between t₋ₙ->t₀ to mark the starting, say tₚ. The utterance is resized to tₚ->t₀->tₘ. At least a portion of the capturable input 202 between t₀->tₘ can represent the activation phase. At least a portion of the capturable input 202 between t₋ₙ->t₀ can represent the pre-activation phase 316. At least a portion of the capturable input 202 between tₚ->t₀ can represent the portion of the pre-activation phase 316 processed by the interpret module 510 with the activation phase 318 to interpret the capturable input 202.

As an example, the assumption is that the tₘ end point is determined by listening activation button press or the end of the activation length 326. There is another possibility that the button is not pressed and automatic endpoint is detected for the final “end-of-utterance” determination.

Although the activation button was pressed at t₀ the utterance contains data from tₚ->t₀ for a more accurate interpretation of the capturable input 202. Now the electronic system 100 behaves the same way and returns the recognition results. The temporary register does not have to be committed to the recognizer without the explicit activation button press. The flow can progress to the de-activate module 512.

The de-activate module 512 provides an invocation to the electronic system 100 to end the activation phase 318. The de-activate module 512 detected the deactivation trigger 308, if it exists, to stop the electronic system 100 from continuing to capture the capturable input 202 past the activation phase 318. If the deactivation trigger 308 is provided, then this will provide the limit of the activation length 326 of FIG. 3. The flow can progress to the post activation capture module 508.

The post-activation capture module 514 provides capturing the capturable input 202 beyond that activation length 326. The post-activation capture module 514 can continue to capture the capturable input 202 up to the post length 328 beyond the end of the activation phase 318.

The interpret module 510 can utilize a portion of the post-activation phase 320 if the interpretation is unsuccessful or if the interpretation is at a low confidence level. The interpret module 510 can utilize the post-activation phase 320 in a number of ways.

For example, the interpret module 510 can function similarly as with the pre-activation phase 316. The interpret module 510 can progressively process portions of the post-activation phase 320 starting with the portion closest to the activation phase 318 and demarked by the closest instance of the capture markers 324. The interpret module 510 can continue to utilize more of the post-activation phase 320 in each interpretation variation up to the post length 328 of FIG. 3.

As an example, the interpret module 510 can use the post-activation phase 320 or a portion of it with the activation phase 318 and without the pre-activation phase 316. The interpret module 510 can utilize all of or portions of the post-activation phase 320, the pre-activation phase 316, the activation phase 318, or a combination thereof. The portions utilized by the interpret module 510 from any of these phases 302 of FIG. 1 can be between adjacent instances of the capture markers 324.

It has been discovered the electronic system 100 provide more accurate interpretation of the capturable input 202 but utilization portions of it outside any triggers 304 for the intended capture to occur for interpretation.

The physical transformation from processing capturable input 202 to provide follow-up functions such as operating upon the voice command interpreted from the capturable input 202. As in the example shown in FIG. 2, this processing can generate a route that can be used to travel in physical geographic locations.

The first software 426 of FIG. 4 of the first device 102 of FIG. 4 can include the modules for the electronic system 100. For example, the first software 426 can include the modules described.

The first control unit 412 of FIG. 4 can execute the first software 426. The second software 442 of FIG. 4 of the second device 106 of FIG. 4 can include the modules for the electronic system 100. The second control unit 434 of FIG. 4 can execute the second software 442.

The modules of the electronic system 100 can be partitioned between the first software 426 and the second software 442. The second control unit 434 can execute modules partitioned on the second software 442 as previously described.

The modules of the electronic system 100 can utilize the first communication unit 416 of FIG. 4, the second communication unit 436 of FIG. 4, or a combination thereof to communicate to and from the modules themselves or external to the electronic system 100. The modules of the electronic system 100 can utilize the first storage unit 414 of FIG. 4, the second storage unit 446 of FIG. 4, or a combination thereof to store information as needed by the execution or operation of the electronic system 100. The modules of the electronic system 100 can utilize the first user interface 418 of FIG. 4, the second user interface 438 of FIG. 4, or a combination thereof for the electronic system 100 to interact to the external world, such as receiving the capturable input 202.

The electronic system 100 describes the module functions or order as an example. The modules can be partitioned differently. Each of the modules can operate individually and independently of the other modules. Furthermore, data generated in one module can be used by another module without being directly coupled to each other. Further, one module communicating to another module can represent one module sending, receiving, or a combination thereof the data generated to or from another module.

The modules described in this application can be hardware implementation or hardware accelerators in the first control unit 412 or in the second control unit 434. The modules can also be hardware implementation or hardware accelerators within the first device 102 or the second device 106 but outside of the first control unit 412 or the second control unit 434, respectively as depicted in FIG. 4. However, it is understood that the first control unit 412, the second control unit 434, or a combination thereof can collectively refer to all hardware accelerators for the modules. Furthermore, the first control unit 412, the second control unit 434, or a combination thereof can be implemented as software, hardware, or a combination thereof.

The modules described in this application can be implemented as instructions stored on a non-transitory computer readable medium to be executed by the first control unit 412, the second control unit 434, or a combination thereof. The non-transitory computer medium can include the first storage unit 414, the second storage unit 446 of FIG. 4, or a combination thereof. The non-transitory computer readable medium can include non-volatile memory, such as a hard disk drive, non-volatile random access memory (NVRAM), solid-state storage device (SSD), compact disk (CD), digital video disk (DVD), or universal serial bus (USB) flash memory devices. The non-transitory computer readable medium can be integrated as a part of the electronic system 100 or installed as a removable portion of the electronic system 100.

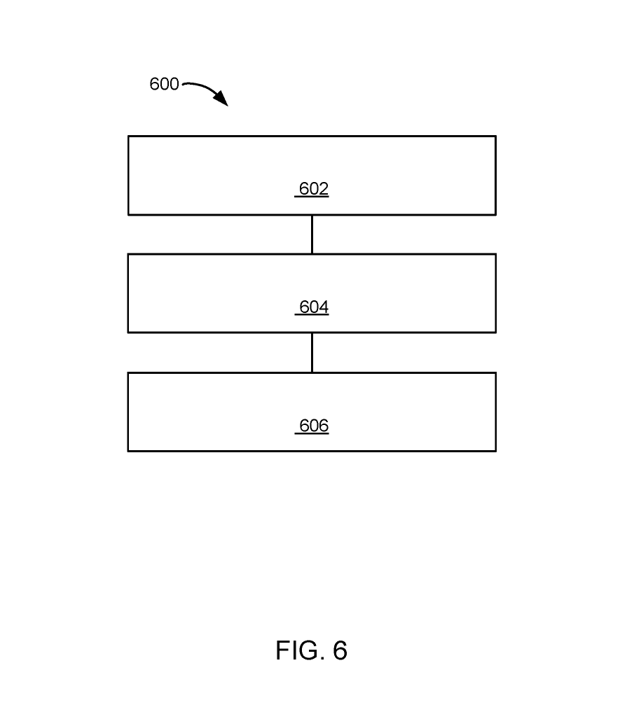

Referring now to FIG. 6, therein is shown a flow chart of a method 600 of operation of the electronic system 100 in a further embodiment of the present invention. The method 600 includes: receiving a trigger for a capturable input including an activation phase, a pre-activation phase and a post-activation phase in a block 602; generating an interpretation from the capturable input based on a portion of the capturable input including an activation phase with at least a portion from the pre-activation phase or the post-activation phase in a block 604; and issuing an operation based on the interpretation in a block 606.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the present invention is that it valuably supports and services the historical trend of reducing costs, simplifying systems, and increasing performance. These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of an electronic system comprising:
receiving a trigger for a capturable input including an activation phase, a pre-activation phase and a post-activation phase;
generating an interpretation from the capturable input based on a portion of the capturable input including an activation phase with at least a portion from the pre-activation phase or the post-activation phase; and
issuing an operation based on the interpretation.

2. The method as claimed in claim 1 wherein interpreting the capturable input based on at least a portion from the pre-activation phase includes determining a capture marker in the pre-activation phase.

3. The method as claimed in claim 1 wherein interpreting the capturable input based on at least a portion from the pre-activation phase and a pre-activation length before the activation phase.

4. The method as claimed in claim 1 wherein interpreting the capturable input based on at least a portion from the post-activation phase includes determining a capture marker in the post-activation phase.

5. The method as claimed in claim 1 wherein interpreting the capturable input based on at least a portion from the post-activation phase and a post length after the activation phase.

6. The method as claimed in claim 1 wherein interpreting the capturable input based on at least a portion from the pre-activation phase includes determining multiple instances of a capture marker in the pre-activation phase.

7. The method as claimed in claim 1 wherein detecting the trigger includes detecting a sensed trigger.

8. The method as claimed in claim 1 wherein detecting the trigger includes detecting an activation trigger.

9. The method as claimed in claim 1 further comprising detecting a deactivation trigger to terminate receiving the capturable input.

10. The method as claimed in claim 1 wherein interpreting the capturable input based on less than an activation length of the activation phase.

11. An electronic system comprising:
a communication unit configured to:
receive a trigger for a capturable input including an activation phase, a pre-activation phase and a post-activation phase;
a control unit, coupled to the communication unit, configured to:
generate an interpretation from the capturable input based on a portion of the capturable input including an activation phase with at least a portion from the pre-activation phase or the post-activation phase; and
issue an operation based on the interpretation.

12. The system as claimed in claim 11 wherein the control unit is further configured to interpret the capturable input based on at least a portion from the pre-activation phase including determining a capture marker in the pre-activation phase.

13. The system as claimed in claim 11 wherein the control unit is further configured to interpret the capturable input based on at least a portion from the pre-activation phase and a pre-activation length before the activation phase.

14. The system as claimed in claim 11 wherein the control unit is further configured to interpret the capturable input based on at least a portion from the post-activation phase including determining a capture marker in the post-activation phase.

15. The system as claimed in claim 11 wherein the control unit is further configured to interpret the capturable input based on at least a portion from the post-activation phase and a post length after the activation phase.

16. A non-transitory computer readable medium including instructions for execution, the instructions comprising:
receiving a trigger for a capturable input including an activation phase, a pre-activation phase and a post-activation phase;
generating an interpretation from the capturable input based on a portion of the capturable input including an activation phase with at least a portion from the pre-activation phase or the post-activation phase; and
issuing an operation based on the interpretation.

17. The medium as claimed in claim 16 wherein interpreting the capturable input based on at least a portion from the pre-activation phase includes determining a capture marker in the pre-activation phase.

18. The medium as claimed in claim 16 wherein interpreting the capturable input based on at least a portion from the pre-activation phase and a pre-activation length before the activation phase.

19. The medium as claimed in claim 16 wherein interpreting the capturable input based on at least a portion from the post-activation phase includes determining a capture marker in the post-activation phase.

20. The medium as claimed in claim 16 wherein interpreting the capturable input based on at least a portion from the post-activation phase and a post length after the activation phase.
